(19) United States
(12) Patent Application Publication
(10) Pub. No.: US 2015/0370539 A1
(43) Pub. Date: Dec. 24, 2015

(54) TRANSITIVE RELATIONSHIP IN MODEL DIAGRAM WITH ELEMENTS AND RELATIONSHIPS

(71) Applicant: International Business Machines Corporation, Armonk, NY (US)

(72) Inventors: Sanjesh R. Nair, Bangalore (IN); Senthil K. Venkatesan, Bangalore (IN)

(21) Appl. No.: 14/310,043

(22) Filed: Jun. 20, 2014

(51) Int. Cl. G06F 9/44; H04L 29/08

(52) U.S. Cl. CPC G06F 8/20; H04L 67/10

(57) ABSTRACT

Depicting a UML (unified modeling language) model by: (i) receiving data model data corresponding to a data model including: (a) a plurality of entity nodes, (b) a plurality of transitive relationship links, with each transitive relationship link directly linking two entity nodes, and (c) a plurality of non-transitive relationship links, with each non-transitive relationship link directly linking two entity nodes; and (ii) presenting a presented portion of the data model, with presented portion including at least one transitive relationship link(s) and at least one non-transitive relationship link(s). The presentation of the presented portion includes at least one of the following features: (i) transitive relationship link(s) of the presented portion are presented in a different manner than the non-transitive relationship link(s) of the presented portion; and/or (ii) at least one connection path is represented as a multiple link path.

### BACKGROUND OF THE INVENTION

The present invention relates generally to the field of software model diagrams, and more particularly to a relationship between UML (unified modeling language) elements.

UML offers a standard way to visualize a systems architectural blueprint, including elements such as business processes, database schemas, logical components, programming language statements, and/or reusable software components. UML typically combines techniques from data modeling, relationship diagrams, business modeling, workflows, object modeling, and/or component modeling. UML can be used with all processes throughout the software development life cycle and/or across different implementation technologies. UML models may be automatically transformed to other representations, such as Java, by means of other transformation languages. UML: (i) is not a stand alone development method; and (ii) typically is compatible with object oriented software development methods.

One known type of relationship between entities is called a “transitive relationship.” There is a transitive relationship between x, y and z if the following condition is met: whenever an element x is related to an element y, and y is in turn related to an element z, then x is also related to z. Transitive relationships can be contrasted with anti transitive relationships, such as the following example of an anti transitive relationship: (i) Mary is the mother of Nancy; (ii) Nancy is the mother of Oliver; and (iii) Mary is not the mother of Oliver. This is anti transitive because Mary can never be the mother of Oliver (as would be the case if motherhood were a transitive relationship rather than an anti transitive one). Further examples of transitive relations are as follows: (i) “is a subset of” (set inclusion); (ii) “divides” (divisibility); and (iii) “implies” (implication).

### SUMMARY

According to an aspect of the present invention, there is a method, computer program product and/or system that performs the following steps (not necessarily in the following order): (i) receiving data model data corresponding to a data model including: (a) a plurality of entity nodes, (b) a plurality of transitive relationship links, with each transitive relationship link directly linking two entity nodes, and (c) a plurality of non-transitive relationship links, with each non-transitive relationship link directly linking two entity nodes; and (ii) presenting a presented portion of the data model, with presented portion including at least one transitive relationship link(s) and at least one non-transitive relationship link(s). The presentation of the presented portion includes at least one of the following features: (i) transitive relationship link(s) of the presented portion are presented in a different manner than the non-transitive relationship link(s) of the presented portion and/or (ii) at least one connection path is represented as a multiple link path.

### BRIEF DESCRIPTION OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system;

FIGS. 4A, B and C are successive screenshots generated by the first embodiment system;

FIG. 5 is a diagram view of a data model according to the present invention;

FIG. 6 is another diagram view of a data model according to the present invention;

FIG. 7 is another diagram view of a data model according to the present invention;

FIG. 8 is another diagram view of a data model according to the present invention; and

FIG. 9 is another diagram view of a data model according to the present invention.

### DETAILED DESCRIPTION

Some embodiments of the present invention may include one, or more, of the following features, characteristics and/or advantages: (i) transitive relationship links in a diagram are presented differently than non-transitive relationship links; and/or (ii) the selection of which entity nodes to show in presentation (for example, visual display) of a diagram depends, in part, upon the transivity or non-transivity of relationship between a given entity node and certain other nodes of the diagram. This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

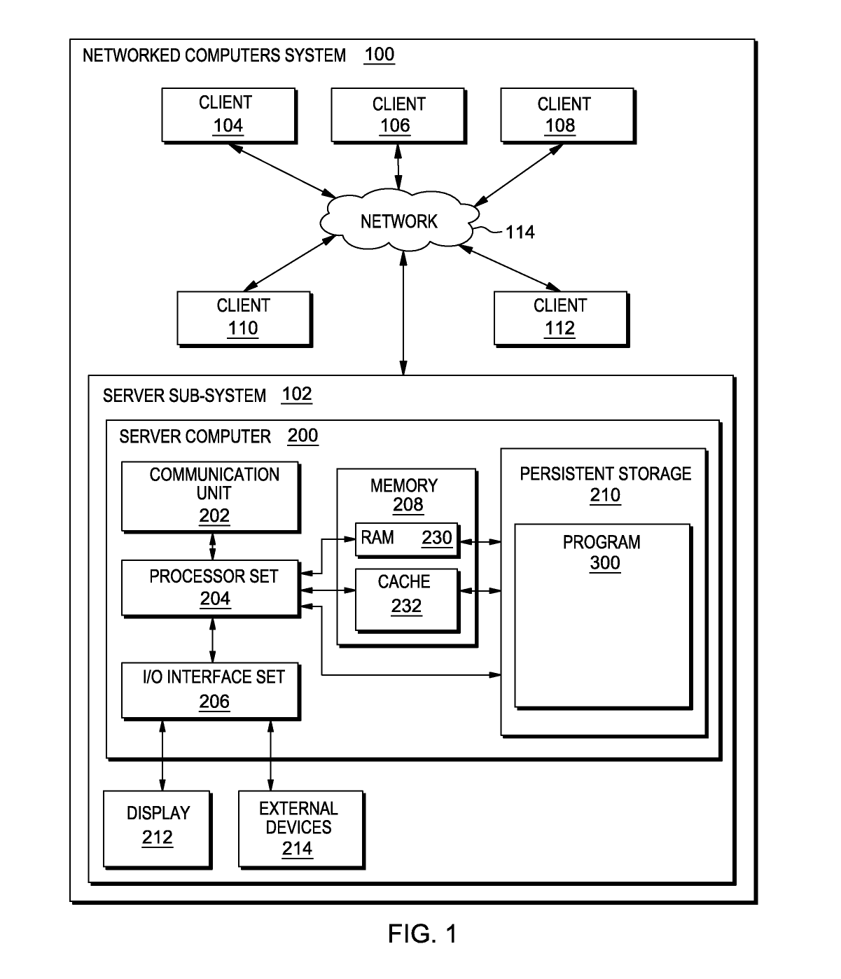

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. Example Embodiment

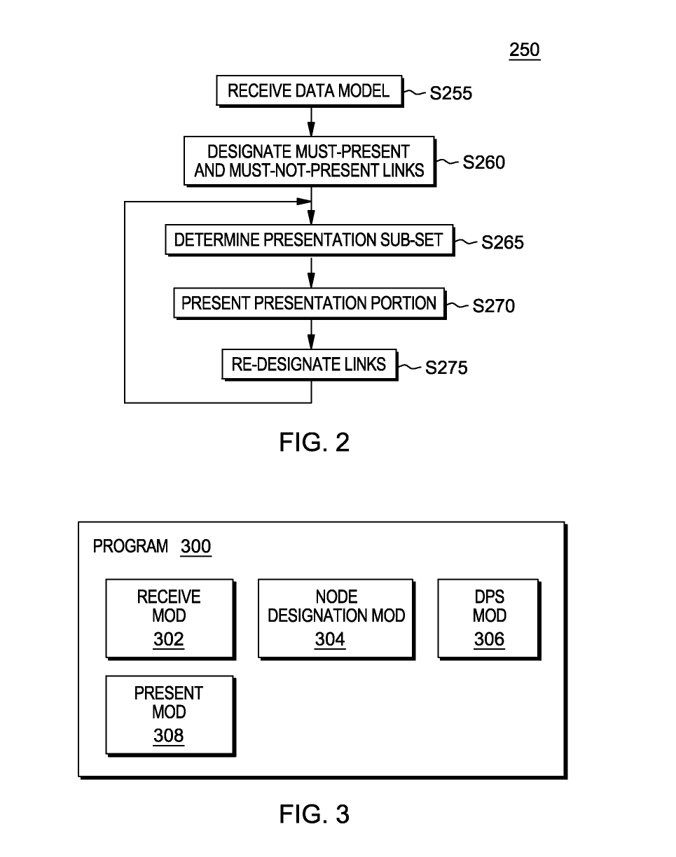

FIG. 2 shows flowchart 250 depicting a method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where receive module (“mod”) 302 receives data corresponding to a UML data model. This UML data model (and/or portions thereof) can be presented in human understandable form and format, such as by a visual display. The data includes: (i) entity nodes; and (ii) relationships between entity nodes. One way that the relationships can be classified is as follows: (a) transitive relationship links; and (b) non-transitive relationship links. Two entity nodes of the UML data model may be: (i) not directly connected by any relationship link; (ii) directly connected by transitive relationship link(s) only; (iii) directly connected by a non-transitive relationship link(s) only; or (iv) directly connected by one, or more, transitive relationship link(s) and one, or more, non-transitive relationship link(s).

Processing proceeds to step S260 where node designation mod 304, in preparation for presenting the UML data model to a human user in human understandable form and format, designates each entity link as: (i) must-present; (ii) must-not-present; or (iii) may-present. As will be discussed below, these designations may change later on, but step S260 represents an initial designation for this embodiment. More particularly, in this embodiment, step S260 initially designates all entity nodes as “must-present.”

Processing proceeds to step S265, where determine presentation sub-set (DPS) mod 306 determines which entity nodes and relationships will be presented in the human understandable presentation of the UML data model. On this initial run-through, this determination is trivial because all entity nodes (A, B, C, D, E, F, G, H) have been designated as “must-present” so that each and every entity node, and all relationships, will be included in the initial presentation. Step S265 will be discussed again later in contexts where not every link is designated as “must-present,” with the result that more complicated rules will govern which entity nodes, and which relationships, are included in a UML presentation.

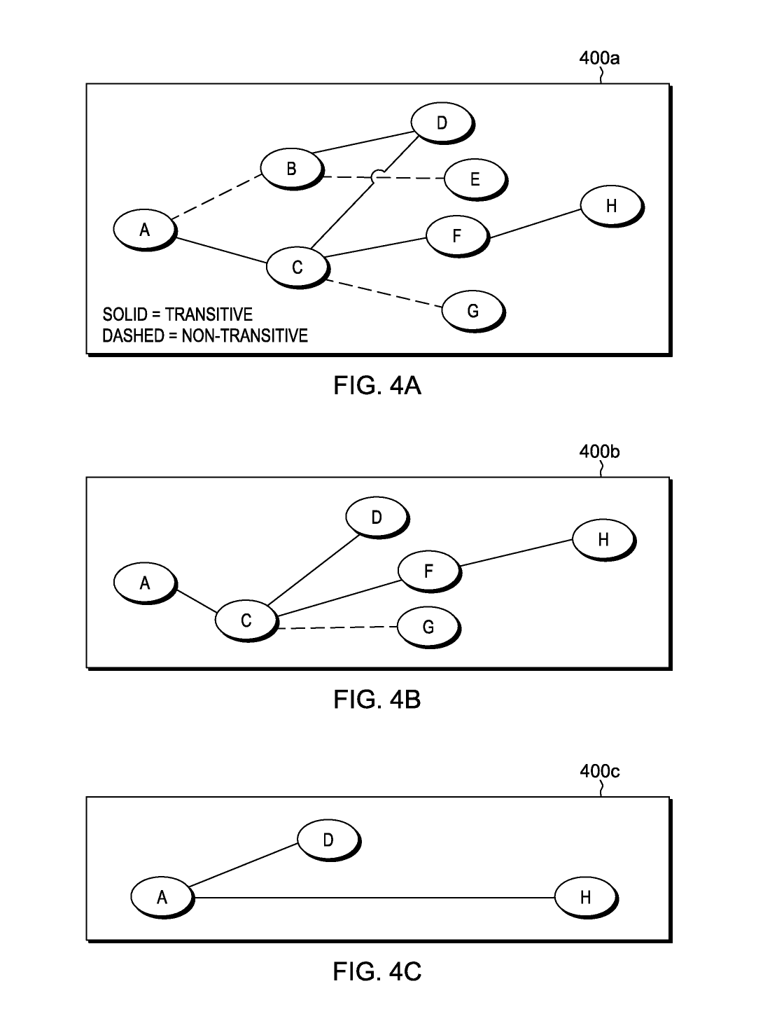

Processing proceeds to step S270 where present mod 308 makes the presentation. In this embodiment, the presentation is a visual display on display device 212 (see FIG. 1). Alternatively, the presentation may be sent to one, or more, of the client sub-systems 104, 106, 108, 110, 112. The initial presentation is shown in screenshot 400a of FIG. 4A. In screenshot 400a, all entity nodes of the UML data model, as well as all relationships present in the UML data model, are represented visually for a human user to see. As indicated in screenshot 400a: (i) transitive relationship links are shown by solid lines; and (ii) non-transitive relationship links are shown by dashed lines. This is just one way that transitive relationship links may be depicted differently than non-transitive relationship links. Other ways of differently presenting transitive and non-transitive relationship links will be further discussed, below, in the Further Comments And/Or Embodiments sub-section of this detailed description section.

Processing proceeds to step S275, where node designation mod 304 re-designates some of the entity nodes with respect to the “must-present,” “may-present,” and “must-not-present” categories. In this embodiment, this re-designation is based on user input. More specifically, in this particular example, a user has re-designated: (i) entity node B from “must-present” to “must-not-present”; and (ii) entity nodes C, D, E, F, G, H from “must-present” to “may-present.” It is noted that node A remains as “must-present” status. Alternatively, some, or all of this re-designation could be accomplished through software. For example, in one alternative embodiment the user may choose an option to “simplify diagram based on node importance,” and the software may figure out corresponding entity node designations.

Processing loops back to step S265 where DPS mod 306 once again determines a “presentation sub-set” of entity nodes and relationship links to include in a new presentation (the “second presentation”) to the user. Upon this second performance of S265, the following rules are used to decide which entity nodes to include in the second presentation: (i) must-present nodes must be presented; (ii) must-not-present nodes must not be presented; (iii) a may-present nodes is only included if it meets at least one of the following conditions: (a) has at least one direct relationship link (transitive or non-transitive) with another entity node in the display presentation sub-set, or (b) is indirectly related to another entity node in the display presentation sub-set by a path made up of transitive relationships (even if this indirect path of transitive relationship links passes through one, or more, must-not-present status entity node(s)). Applying this set of rules for the second presentation, where B is now must-not-present and C to H are may-present, the display presentation sub-set will: (i) include node A because it is must-present; (ii) not include node B because it is now must-not present; (iii) include nodes D, F, G and H because they all have direct relationship links to other nodes in the display presentation subset; and (iv) not include node E because it has no direct link to another node in the display presentation sub-set and no indirect transitive relationship to any node in the display presentation sub-set.

Processing proceeds again to step S270, where present mod 308 generates new screenshot 400b (see FIG. 4B). Screenshot 400b includes the entity nodes determined to be in the display presentation sub-set and all the relationship links between them. As can be seen by comparing screenshots 400a and 400b, entity nodes B and E are no longer presented, which somewhat simplifies the presentation of the UML data model.

Processing proceeds again to step S275 where the following designations are made for a third presentation: (i) node A is designated as must-present; (ii) nodes B, C and F are designated as must-not-present; and (iii) nodes D, E, G and H are designated as may-present.

Processing again loops back to step S265 where DPS mod 306 once again determines a “presentation sub-set” of entity nodes and relationship links for the third presentation. Upon this third performance of S265, the rules, set forth above, are again used to decide which entity nodes to include in the third presentation. Applying the above-mentioned set of rules for the third presentation, the display presentation sub-set will: (i) include node A because it is must-present; (ii) not include nodes B, C and F because they are now must-not present; (iii) include node H because it has an indirect relationship connection, made up of transitive relationship links, to node A; and (iv) include node D because it has an indirect relationship connection, made up of transitive relationship links, to node A.

Processing proceeds again to step S270, where present mod 308 generates new screenshot 400c (see FIG. 4C). Screenshot 400b includes the entity nodes determined to be in the display presentation sub-set and all the relationship links between them. The indirect transitive relationship between node A and node H is shown as a single transitive relationship link because intermediate nodes C and F are no longer included in the third presentation.

### III. Further Comments and/or Embodiments

In a model diagram the following are depicted: (i) the elements of the model; and (ii) relationships between the elements of the model. For instance, assume a class diagram where Class A extends Class B, which in turn implements Interface I. If B has to be hidden, then the relationships (connectors for generalization relationship and realization relationship) are also discarded from diagram. To solve the above problem, the relation between class ‘A’ and interface ‘I’ can be shown via a ‘Transitive Relation’ from A to I. This ‘Transitive Relation’ can be a simple arrow or a combined (Extends and Realization) arrow. In some embodiments of the present invention, this ‘Transitive Relation’ is used in generating and/or presenting (for example, displaying) UML models. In a UML Diagram, to depict a relation between two UML elements which are related but not directly, the following notations are proposed: (i) hybrid relation notation by combining the notations of all relations that connect the source and target elements; (ii) a new notation (transitive relation) to represent this kind of indirect relation; and/or (iii) a relation annotated with count of the number of elements that are present in between the source and target elements. This new relation has to be shown when the intermediate elements in the entire connection between source and target are removed from the diagram.

Some embodiments of the present invention may include one, or more, of the following features, characteristics and/or advantages: (i) establish a hybrid relation notation by combining the notations of all relations that connect the source and target elements; (ii) establish a new notation (transitive relation) to represent this kind of indirect relation; and/or (iii) establish a relation annotated by counting the number of elements that are present in between the source and target elements. This new relation has to be shown when the intermediate elements in the entire connection between source and target are removed from the diagram.

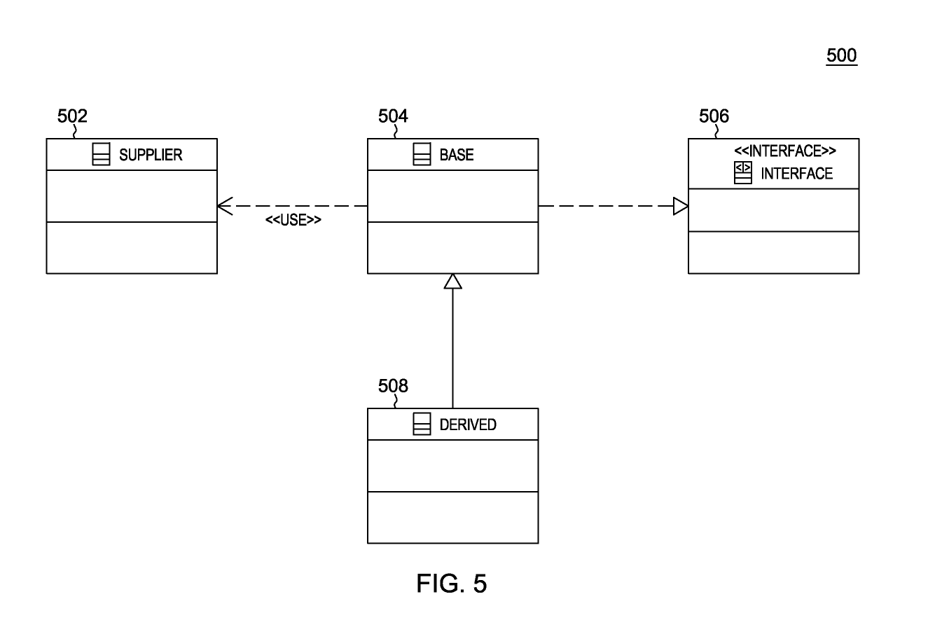

FIGS. 5 through 9 are UML data models illustrating various aspects of the present invention including schematic views 500, 700, and 800. These methods further include supplier element (classes) 502; base class 504; interface class 506; derived class 508; information balloons 510 and 512; request blocks 702, 704, 706, 708, 710; controllers 712, 714, 716, 718, 720; and java server page views 722, 724, 726, 728, 730.

As shown in FIG. 5, consider the model elements (classes) and their relationships, noting that if base class 504 is hidden, there is no way, under conventional technology, to show the dependency between the other classes (supplier class 502, interface class 506, and/or delivered class 508) although they are related.

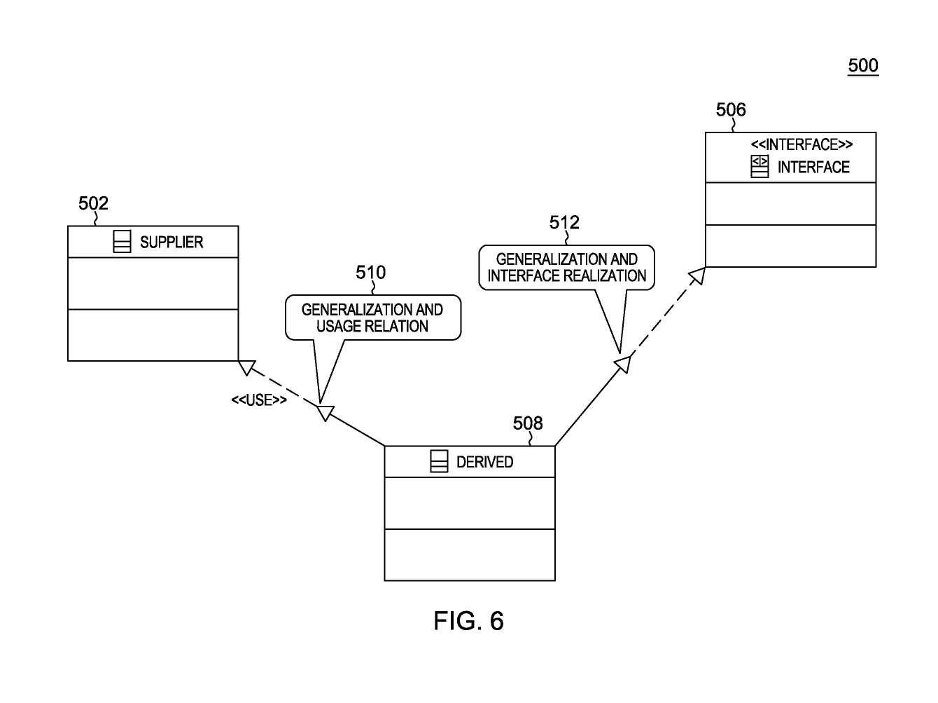

As shown in FIG. 6, if the base class 504 is hidden (not shown), the relationships can still be shown through the combination of all the connectors between the visible elements. In diagram 500 of FIG. 6, information balloons 510 and 512 each point at a “multiple link path” according to the present invention. More specifically, each of the paths to which the information balloons point are made up of two segments, with each segment terminating in an arrowhead. Each segment represents a link, which is to say a direct connection path between two entities existing in the model. However, the arrowhead indicated by information balloon 510 indicates that there is an intermediate entity (or node) between nodes 502 and 508 which: (i) exists in the model; but (ii) is not shown in diagram 500. In other words, in the model: (i) there is a link between node 502 and some intermediate node (see FIG. 5 at node 504); and there is a link between that intermediate node and node 508. Similarly, in the model: (i) there is a link between node 506 and some intermediate node (see FIG. 5 at node 504); and there is a link between that intermediate node and node 508. While this intermediate node is not displayed to the user in the display of diagram 500, this node is inferentially indicated by the “multiple link paths.”

In the embodiment of FIG. 6, each link of a multiple link path is indicated by a path segment terminating in an arrowhead. Alternatively, a multiple link path may be indicated in other ways (color codes, etc.). However, if the intermediate node itself is shown (see FIG. 5 at node 504) then the paths are not considered as “multiple link paths” as that term is used in this document. In other words: (i) FIG. 5 does not include any “multiple link path” representations; (ii) FIG. 6 is a display of the same model as that of FIG. 5; and (iii) FIG. 6 does include “multiple link path” representations according to an embodiment of the present invention.

It is noted that in each multiple link path of FIG. 6: (i) one path is shown in a solid line; and (ii) one path is shown in a dashed line. This choice of solid versus dashed line presentation is made by machine logic based upon whether the link is transitive or non-transitive. Because the two multiple link paths of diagram 500 each include at least one transitive link, and at least one non-transitive link, these multiple link paths are called hybrid multiple link paths. While the embodiment of FIG. 6 indicates transivity status of each link of its multiple link paths, other embodiments may represent every link in the same manner, regardless of transivity status.

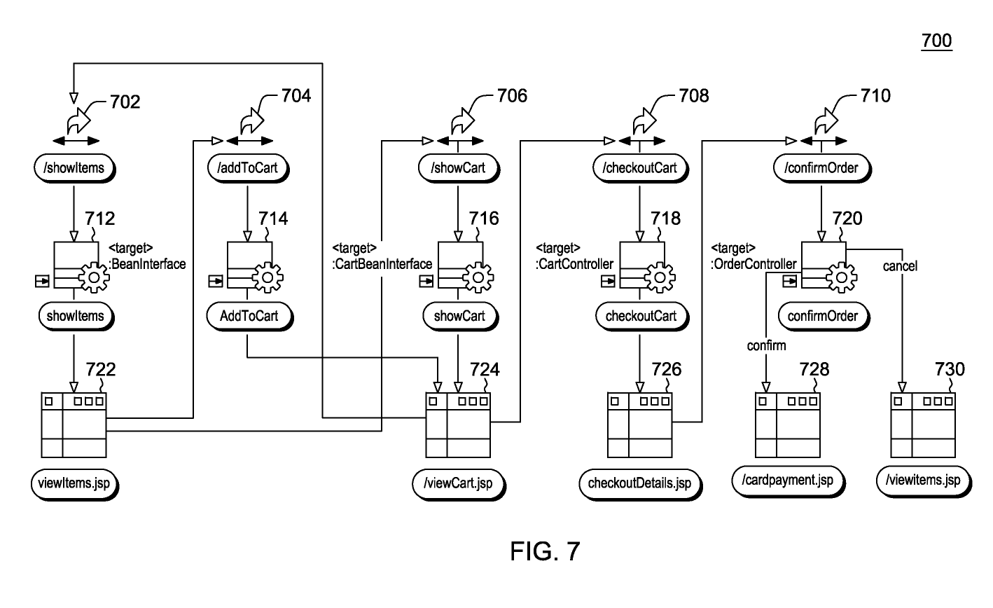

As shown in FIG. 7, consider an example from the Spring MVC (model-view-controller) domain. Various views (.jsp (javaserver pages) files) are connected to each other in the flow, which pass through a number of request blocks and controller classes/methods.

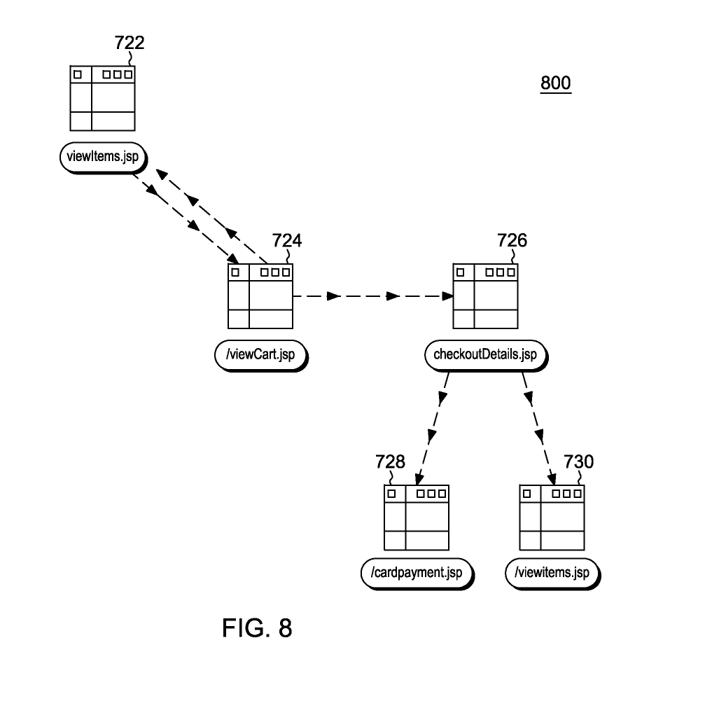

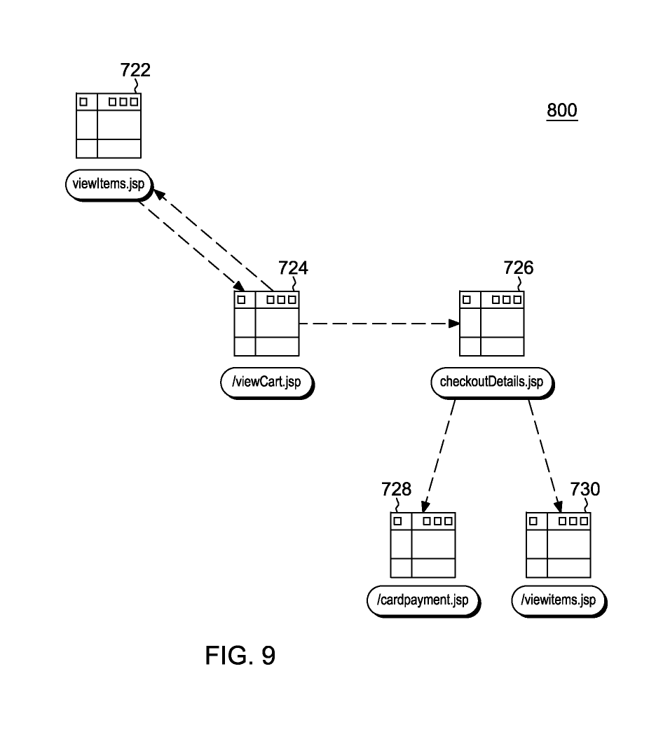

As shown in FIG. 8, some embodiments of the present invention may further recognize: (i) how the views are connected to each other; and/or (ii) how to find how a particular view can be reached. Furthermore, FIG. 8 is a display of a UML model (that is, the UML model shown more fully in FIG. 7) using multiple link paths. FIG. 9 is an alternative display of the same UML model (that is, the UML model shown more fully in FIG. 7) which does not use multiple path links, but does indicate (by dashed lines) the transivity status of its displayed connection paths.

Some embodiments of the present invention may further include one, or more, of the following features, characteristics and/or advantages: (i) establish a hybrid relation notation by combining the notations of all relations that connect the source and target elements; (ii) establish a new notation (transitive relation) to represent this kind of indirect relation; and/or (iii) establish a relation annotated by counting the number of elements that are present in between the source and target elements. This new relation has to be shown when the intermediate elements in the entire connection between source and target are removed from the diagram.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Electrically Connected: means either directly electrically connected, or indirectly electrically connected, such that intervening elements are present; in an indirect electrical connection, the intervening elements may include inductors and/or transformers.

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, quick-release connections, latches and/or magnetic connections), force fit connections, friction fit connections, connections secured by engagement caused by gravitational forces, pivoting or rotatable connections, and/or slidable mechanical connections.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

What is claimed is:

1. A method comprising:
receiving data model data corresponding to a data model including: (i) a plurality of entity nodes, (ii) a plurality of transitive relationship links, with each transitive relationship link directly linking two entity nodes, and (iii) a plurality of non-transitive relationship links, with each non-transitive relationship link directly linking two entity nodes; and
presenting a presented portion of the data model, with presented portion including at least one transitive relationship link(s) and at least one non-transitive relationship link(s);
wherein:
the presentation of the presented portion includes at least one of the following features: (i) transitive relationship link(s) of the presented portion are presented in a different manner than the non-transitive relationship link(s) of the presented portion and/or (ii) at least one connection path is represented as a multiple link path.

2. The method of claim 1 wherein:
in the presentation of the presented portion, at least one connection path is represented as a multiple link path;
the at one multiple link path includes at least one transitive link and at least one non-transitive link; and
transitive link(s) of the at least one multiple link path are presented in a different manner than the non-transitive link(s) of the multiple link path.

3. The method of claim 1 further comprising:
receiving a designation of at least one must-present entity node(s) which are to be included in the presented portion;
receiving a designation of at least one must-not-present entity node(s) which are not to be included in the presented portion; and
determining a presentation sub-set of entity node(s) of the plurality of entity nodes, with the presentation sub-set of entity node(s) representing all entity nodes to be included in the presented portion, where the determination of the presentation sub-set of entity(s) determines an entity node to be in the presentation sub-set of entity node(s) if it meets both of the following conditions: (i) it is not designated as a must-not-present entity node, and (ii) it is either designated as a must-present entity node or is linked to a must-present entity node through one, or more, transitive relationship links.

4. The method of claim 3 wherein:
a first entity node is not a must-present entity node;
a second entity node is a must-not-present entity node;
the second entity node is linked to the first entity node by a transitive relationship link;
a third entity node designated neither as a must-present entity node or a must-not-present entity node;
the third entity node is linked to the second entity node by a transitive relationship link; and
the presentation of the presentation portion includes the first node, the third node and a transitive relationship link between the first and third nodes.

5. The method of claim 3 further comprising:
re-designating a first entity node as a must-not present node; and
re-determining the presentation sub-set of entity node(s) of the plurality of entity nodes, with the presentation sub-set of entity node(s) representing all entity nodes to be included in the presented portion, where the determination of the presentation sub-set of entity(s) determines an entity node to be in the presentation sub-set of entity node(s) if it meets both of the following conditions: (i) it is not designated as a must-not-present entity node, and (ii) it is either designated as a must-present entity node or is linked to a must-present entity node through one, or more, transitive relationship links.

6. The method of claim 1 wherein:
a first entity node has both a transitive and non-transitive relationship link with a second entity node; and
the presentation of the transitive and non-transitive links between the first and second entities are presented in a different manner than: (i) links between entity nodes that only have a non-transitive relationship, and (ii) links between entity nodes that only have a transitive relationship.

7. A computer program product comprising a computer readable storage medium having stored thereon:
first program instructions programmed to receive data model data corresponding to a data model including: (i) a plurality of entity nodes, (ii) a plurality of transitive relationship links, with each transitive relationship link directly linking two entity nodes, and (iii) a plurality of non-transitive relationship links, with each non-transitive relationship link directly linking two entity nodes; and
second program instructions programmed to present a presented portion of the data model, with presented portion including at least one transitive relationship link(s) and at least one non-transitive relationship link(s);
wherein:
the presentation of the presented portion includes at least one of the following features: (i) transitive relationship link(s) of the presented portion are presented in a different manner than the non-transitive relationship link(s) of the presented portion, and/or (ii) at least one connection path is represented as a multiple link path.

8. The product of claim 7 wherein:
in the presentation of the presented portion, at least one connection path is represented as a multiple link path;
the at one multiple link path includes at least one transitive link and at least one non-transitive link; and
transitive link(s) of the at least one multiple link path are presented in a different manner than the non-transitive link(s) of the multiple link path.

9. The product of claim 7 wherein the medium has further stored thereon:
third program instructions programmed to receive a designation of at least one must-present entity node(s) which are to be included in the presented portion;
fourth program instructions programmed to receive a designation of at least one must-not-present entity node(s) which are not to be included in the presented portion; and
fifth program instructions programmed to determine a presentation sub-set of entity node(s) of the plurality of entity nodes, with the presentation sub-set of entity node(s) representing all entity nodes to be included in the presented portion, where the determination of the presentation sub-set of entity(s) determines an entity node to be in the presentation sub-set of entity node(s) if it meets both of the following conditions: (i) it is not designated as a must-not-present entity node, and (ii) it is either designated as a must-present entity node or is linked to a must-present entity node through one, or more, transitive relationship links.

10. The product of claim 9 wherein:
a first entity node is not a must-present entity node;
a second entity node is a must-not-present entity node;
the second entity node is linked to the first entity node by a transitive relationship link;
a third entity node designated neither as a must-present entity node or a must-not-present entity node;
the third entity node is linked to the second entity node by a transitive relationship link; and
the presentation of the presentation portion includes the first node, the third node and a transitive relationship link between the first and third nodes.

11. The product of claim 9 wherein the medium has further stored thereon:
sixth program instructions programmed to re-designate a first entity node as a must-not present node; and
seventh program instructions programmed to re-determine the presentation sub-set of entity node(s) of the plurality of entity nodes, with the presentation sub-set of entity node(s) representing all entity nodes to be included in the presented portion, where the determination of the presentation sub-set of entity(s) determines an entity node to be in the presentation sub-set of entity node(s) if it meets both of the following conditions: (i) it is not designated as a must-not-present entity node, and (ii) it is either designated as a must-present entity node or is linked to a must-present entity node through one, or more, transitive relationship links.

12. The product of claim 7 wherein:
a first entity node has both a transitive and non-transitive relationship link with a second entity node; and
the presentation of the transitive and non-transitive links between the first and second entities are presented in a different manner than: (i) links between entity nodes that only have a non-transitive relationship, and (ii) links between entity nodes that only have a transitive relationship.

13. A computer system comprising:
a processor(s) set; and
a computer readable storage medium;
wherein:
the processor set is structured, located, connected and/or programmed to run program instructions stored on the computer readable storage medium; and
the program instructions include:
first program instructions programmed to receive data model data corresponding to a data model including: (i) a plurality of entity nodes, (ii) a plurality of transitive relationship links, with each transitive relationship link directly linking two entity nodes, and (iii) a plurality of non-transitive relationship links, with each non-transitive relationship link directly linking two entity nodes; and
second program instructions programmed to present a presented portion of the data model, with presented portion including at least one transitive relationship link(s) and at least one non-transitive relationship link(s);
wherein:
the presentation of the presented portion includes at least one of the following features: (i) transitive relationship link(s) of the presented portion are presented in a different manner than the non-transitive relationship link(s) of the presented portion, and/or (ii) at least one connection path is represented as a multiple link path.

14. The system of claim 12 wherein:
in the presentation of the presented portion, at least one connection path is represented as a multiple link path;
the at one multiple link path includes at least one transitive link and at least one non-transitive link; and
transitive link(s) of the at least one multiple link path are presented in a different manner than the non-transitive link(s) of the multiple link path.

15. The system of claim 13 wherein the medium has further stored thereon:
third program instructions programmed to receive a designation of at least one must-present entity node(s) which are to be included in the presented portion;
fourth program instructions programmed to receive a designation of at least one must-not-present entity node(s) which are not to be included in the presented portion; and
fifth program instructions programmed to determine a presentation sub-set of entity node(s) of the plurality of entity nodes, with the presentation sub-set of entity node(s) representing all entity nodes to be included in the presented portion, where the determination of the presentation sub-set of entity(s) determines an entity node to be in the presentation sub-set of entity node(s) if it meets both of the following conditions: (i) it is not designated as a must-not-present entity node, and (ii) it is either designated as a must-present entity node or is linked to a must-present entity node through one, or more, transitive relationship links.

16. The system of claim 15 wherein:
a first entity node is not a must-present entity node;
a second entity node is a must-not-present entity node;
the second entity node is linked to the first entity node by a transitive relationship link;
a third entity node designated neither as a must-present entity node or a must-not-present entity node;
the third entity node is linked to the second entity node by a transitive relationship link; and
the presentation of the presentation portion includes the first node, the third node and a transitive relationship link between the first and third nodes.

17. The system of claim 15 wherein the medium has further stored thereon:
sixth program instructions programmed to re-designate a first entity node as a must-not present node; and
seventh program instructions programmed to re-determine the presentation sub-set of entity node(s) of the plurality of entity nodes, with the presentation sub-set of entity node(s) representing all entity nodes to be included in the presented portion, where the determination of the presentation sub-set of entity(s) determines an entity node to be in the presentation sub-set of entity node(s) if it meets both of the following conditions: (i) it is not designated as a must-not-present entity node, and (ii) it is either designated as a must-present entity node or is linked to a must-present entity node through one, or more, transitive relationship links.

18. The system of claim 13 wherein:
a first entity node has both a transitive and non-transitive relationship link with a second entity node; and
the presentation of the transitive and non-transitive links between the first and second entities are presented in a different manner than: (i) links between entity nodes that only have a non-transitive relationship, and (ii) links between entity nodes that have only have a transitive relationship.
